(19) United States
(12) Patent Application Publication
(10) Pub. No.: US 2023/0261834 A1
(43) Pub. Date: Aug. 17, 2023

(54) APERIODIC REFERENCE SIGNAL TRANSMISSION METHOD, TERMINAL, AND NETWORK-SIDE DEVICE

(71) Applicant: VIVO MOBILE COMMUNICATION CO., LTD., Dongguan (CN)

(72) Inventors: Yuan SHI, Dongguan (CN); Rakesh TAMRAKAR, Dongguan (CN)

(73) Assignee: VIVO MOBILE COMMUNICATION CO., LTD., Dongguan (CN)

(21) Appl. No.: 18/136,850

(22) Filed: Apr. 19, 2023

Related U.S. Application Data
(63) Continuation of application No. PCT/CN2021/125030, filed on Oct. 20, 2021.

(30) Foreign Application Priority Data
Oct. 20, 2020 (CN) 202011128902.5

(51) Int. Cl. H04L 5/00; H04W 72/0446; H04W 72/231

(52) U.S. Cl. CPC H04L 5/0051; H04W 72/0446; H04W 72/231

(57) ABSTRACT

An aperiodic Reference Signal (RS) transmission method, a terminal, and a network-side device are provided. The method includes: receiving first slot offset information, where the first slot offset information is for indicating a first slot offset of a target aperiodic RS resource; and transmitting or receiving the target aperiodic RS resource at a first slot position, where the first slot position is determined from any of the following: the first slot offset, and the first slot offset and a second slot offset; or the second slot offset is a slot offset configured for the target aperiodic RS resource.

This application is a continuation of International Application No. PCT/CN2021/125030, filed on Oct. 20, 2021, which claims priority to Chinese Patent Application No. 202011128902.5, filed on Oct. 20, 2020. The entire contents of each of the above-identified applications are expressly incorporated herein by reference.

### TECHNICAL FIELD

This application belongs to the field of communication technologies, and specifically to an aperiodic Reference Signal (RS) transmission method, a terminal, and a network-side device.

### BACKGROUND

Before an aperiodic Reference Signal (RS) resource is transmitted between a network-side device and a terminal, the network-side device needs to configure an aperiodic RS resource for the terminal through Radio Resource Control (RRC) signaling and activate the aperiodic RS resource by transmitting Downlink Control Information (DCI). After receiving the DCI for activation, the activated aperiodic RS resource is transmitted or received.

However, a manner of determining a slot position for a terminal to transmit or receive an aperiodic RS resource is not flexible enough in the related technology.

### SUMMARY

Embodiments of this application provide an aperiodic Reference Signal (RS) transmission method, a terminal, and a network-side device.

According to a first aspect, an aperiodic RS transmission method is provided, applied to a terminal, and the method including: receiving first slot offset information, where the first slot offset information is for indicating a first slot offset of a target aperiodic RS resource; and transmitting or receiving the target aperiodic RS resource at a first slot position, where the first slot position is determined from any of the following: the first slot offset, and the first slot offset and a second slot offset; and the second slot offset is a slot offset configured for the target aperiodic RS resource.

According to a second aspect, an aperiodic RS transmission apparatus is provided, the apparatus including: a receiving module, configured to receive first slot offset information, where the first slot offset information is for indicating a first slot offset of a target aperiodic RS resource; and a transceiver module, configured to transmit or receive the target aperiodic RS resource at a first slot position, where the first slot position is determined from any of the following: the first slot offset, and the first slot offset and a second slot offset; and the second slot offset is a slot offset configured for the target aperiodic RS resource.

According to a third aspect, an aperiodic RS transmission method is provided, applied to a network-side device, and the method including: transmitting first slot offset information, where the first slot offset information is for indicating a first slot offset of a target aperiodic RS resource; and

transmitting or receiving the target aperiodic RS resource at a first slot position, where the first slot position is determined from any of the following: the first slot offset, and the first slot offset and a second slot offset; and the second slot offset is a slot offset configured for the target aperiodic RS resource.

According to a fourth aspect, an aperiodic RS transmission apparatus is provided, the apparatus including: a transmission module, configured to transmit first slot offset information, where the first slot offset information is for indicating a first slot offset of a target aperiodic RS resource; and a transceiver module, configured to transmit or receive the target aperiodic RS resource at a first slot position, where the first slot position is determined from any of the following: the first slot offset, and the first slot offset and a second slot offset; and the second slot offset is a slot offset configured for the target aperiodic RS resource.

According to a fifth aspect, a terminal is provided, the terminal including a processor, a memory, and a program or instructions stored in the memory and executable on the processor, where the program or instructions, when being executed by the processor, implement the steps of the method according to the first aspect.

According to a sixth aspect, a network-side device is provided, the network-side device including a processor, a memory, and a program or instructions stored in the memory and executable on the processor, where the program or instructions, when being executed by the processor, implement the steps of the method according to the first aspect.

According to a seventh aspect, a readable storage medium is provided, the readable storage medium storing a program or instructions, where the program or instructions, when being executed by a processor, implement the steps of the method according to the first aspect, or implement the steps of the method according to the third aspect.

According to an eighth aspect, a chip is provided, the chip including a processor and a communication interface, where the communication interface is coupled to the processor, and the processor is configured to execute a program or instructions of a network-side device to implement the method according to the first aspect or the method according to the third aspect.

In embodiments of this application, a terminal receives first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource.

### BRIEF DESCRIPTION OF THE DRAWINGS

FIG. 1 is a schematic diagram of an architecture of a communication system according to an embodiment of this application;

FIG. 2A is a flowchart of an aperiodic RS transmission method according to an embodiment of this application;

FIG. 2B is a flowchart of an aperiodic RS transmission method according to an embodiment of this application;

FIG. 3 is a schematic diagram of a structure of a terminal according to an embodiment of this application;

FIG. 4 is a schematic diagram of hardware of a communication device according to an embodiment of this application;

FIG. 5 is a schematic diagram of hardware of a terminal according to an embodiment of this application;

FIG. 6 is a schematic diagram of a structure of a network-side device according to an embodiment of this application; and

FIG. 7 is a schematic diagram of hardware of a network-side device according to an embodiment of this application.

### DETAILED DESCRIPTION

The following describes the embodiments of this application with reference to the accompanying drawings in embodiments of this application. Apparently, the described embodiments are some of embodiments of this application rather than all of the embodiments. All other embodiments obtained by a person of ordinary skill in the art based on embodiments of this application without creative efforts shall fall within the protection scope of this application.

The specification and claims of this application, and terms “first” and “second” are used to distinguish similar objects, but are unnecessarily used to describe a specific sequence or order. It may be understood that the data used in such a way is interchangeable in proper circumstances, so that embodiments of this application can be implemented in other sequences than the sequence illustrated or described herein. Objects distinguished by “first” and “second” are usually of one type, and a quantity of the objects is not limited. For example, one or more first objects may be provided. In addition, “and/or” in the specification and claims indicates at least one of the connected objects, and the character “/” generally indicates an “or” relationship between the associated objects.

It needs to be noted that the technology described in embodiments of this application is not limited to a Long Term Evolution (LTE)/LTE-Advanced (LTE-A) system, and may be used in another wireless communication system such as Code Division Multiple Access (CDMA), Time Division Multiple Access (TDMA), Frequency Division Multiple Access (FDMA), Orthogonal Frequency Division Multiple Access (OFDMA), and Single-Carrier Frequency-Division Multiple Access (SC-FDMA), and another system. The terms “system” and “network” are often used interchangeably in embodiments of this application, and the technology described may be used for both the systems and radio technologies mentioned above as well as for other systems and radio technologies. The following descriptions describe New Radio (NR) systems for exemplary purposes and use the term NR for most of the following descriptions. However, these technologies may also be applied to applications other than NR system applications, for example, 6th Generation (6G) communication systems.

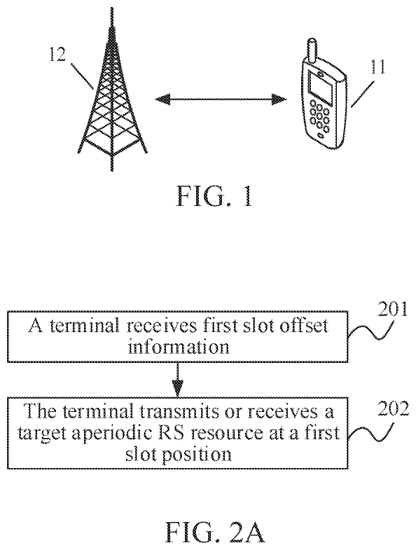

FIG. 1 is a block diagram of a wireless communication system to which an embodiment of this application is applicable. The wireless communication system includes a terminal 11 and a network-side device 12. The terminal 11 may also be referred to as a terminal device or User Equipment (UE). The terminal 11 may be a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device or a Vehicle UE (VUE), a Pedestrian UE (PUE), among other terminal-side devices. The wearable device includes a wristband, headphones, glasses, and the like. It should be noted that the specific type of the terminal 11 is not limited in embodiments of this application. The network-side device 12 may be a base station or a core network. The base station may be referred to as a node B, an evolved node B, an access point, a Base Transceiver Station (BTS), a radio base station, a radio transceiver, a Basic Service Set (BSS), an Extended Service Set (ESS), a B node, an evolved B node (eNB), a home B node, a home evolved B node, a WLAN access point, a Wi-Fi node, a Transmission and Reception Point (TRP) or some other appropriate terms in the field, provided that the same technical effect is achieved. The base station is not limited to a specific technical vocabulary. It needs to be noted that a base station in an NR system is only used as an example in embodiments of this application. However, the specific type of the base station is not limited.

In embodiments of this application, a terminal receives first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource. In the solution, the solution of determining a first slot position through a first slot offset or determining a first slot position through a first slot offset and a second slot offset increases the selectability and flexibility of determining a slot position for the terminal to transmit or receive an aperiodic RS resource, so that the problem that a manner of determining a slot position for the terminal to transmit or receive an aperiodic RS resource is not flexible enough in the related technology can be solved. In addition, the solution increases the selectability and flexibility of delivering a slot position of Downlink Control Information (DCI) for activating the aperiodic RS resource, that is, increases the selectability and flexibility of a slot position for transmitting a Physical Downlink Control CHannel (PDCCH), and can resolve to a certain extent the problem of congestion of PDCCH resources caused by delivery of a plurality of pieces of DCI in the same slot in the related technology.

An aperiodic RS transmission method, a terminal, and a network-side device provided in embodiments of this application are described in detail below by means of some embodiments and their application scenarios in conjunction with the accompanying drawings.

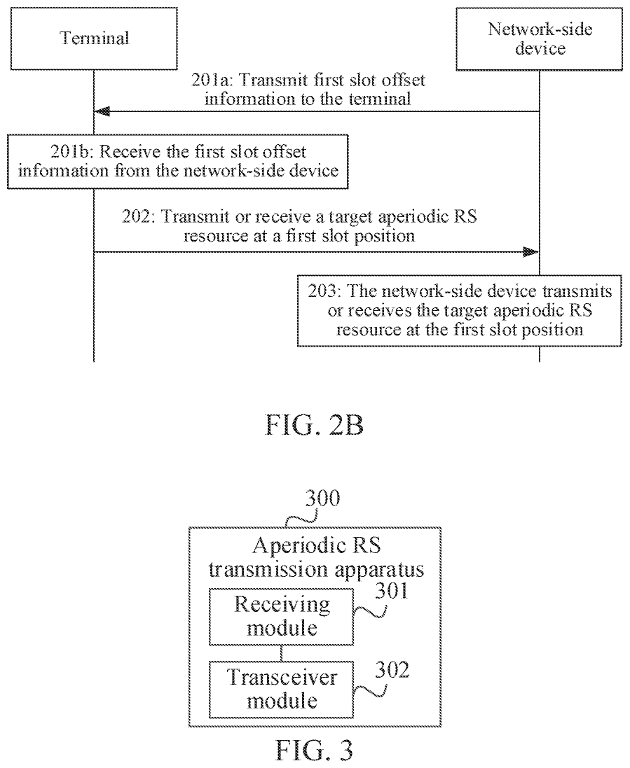

Based on a communication system shown in FIG. 1, embodiments of this application provide an aperiodic RS transmission method. As shown in FIG. 2A, the aperiodic RS transmission method may include the following step 201 to step 203.

Step 201: A terminal receives first slot offset information.

The first slot offset information is for indicating a first slot offset of a target aperiodic RS resource.

Step 202: The terminal transmits or receives the target aperiodic RS resource at a first slot position.

The first slot position is determined from any of the following: the first slot offset, and the first slot offset and a second slot offset; and the second slot offset is a slot offset configured for the target aperiodic RS resource.

In some implementations, correspondingly, the network-side device transmits first slot offset information. As shown in FIG. 2B, in embodiments of this application, before step 201, the aperiodic RS transmission method provided in embodiments of this application may further include step 201a. The foregoing step 201 may be specifically implemented by using the following step 201b.

Step 201a: The network-side device transmits first slot offset information to the terminal.

Step 201b: The terminal receives the first slot offset information from the network-side device.

In some implementations, as shown in FIG. 2B, in embodiments of this application, the aperiodic RS transmission method provided in embodiments of this application may further include the following step 203.

Step 203: The network-side device transmits or receives the target aperiodic RS resource at the first slot position.

For example, the target aperiodic R0S resource includes an aperiodic uplink RS, for example, a Sounding Reference Signal (SRS). In step 202, the terminal transmits the aperiodic uplink RS at the first slot position. Correspondingly, in step 203, the network-side device receives the aperiodic uplink RS at the first slot position. Alternatively, the target aperiodic RS resource includes an aperiodic downlink RS, for example, a Channel State Information Reference Signal (CSI-RS) or a Position Reference Signal (PRS). In step 202, the terminal receives the aperiodic downlink RS at the first slot position. Correspondingly, in step 203, the network-side device transmits the aperiodic downlink RS at the first slot position.

In embodiments of this application, in a case that the first slot position is determined from the first slot offset, a transmission or reception slot position of an aperiodic RS resource can be effectively determined, so that a manner of determining the transmission or reception slot position of the aperiodic RS resource is more flexible.

In embodiments of this application, in a case that the first slot position is determined from the first slot offset and the second slot offset, compared with the solution that the first slot position is determined from the second slot offset in the related technology, a manner of determining the transmission or reception slot position of the aperiodic RS resource is more flexible, so that aperiodic RS resource can be better transmitted or received. In addition, a manner of determining and delivering a slot position of DCI for activating the aperiodic RS resource is also more flexible, that is, a manner of determining a slot position for transmitting a PDCCH is more flexible. In this way, the problem of congestion of PDCCH resources caused by delivery of a plurality of pieces of DCI in the same slot in the related technology can be resolved to a certain extent.

In some implementations, the target aperiodic RS resource includes at least one of the following: a target aperiodic SRS resource and a target aperiodic CSI-RS resource.

It should be noted that, in embodiments of this application, the target aperiodic RS resource may be an aperiodic RS resource of another type, and may be specifically determined according to an actual case. This is not limited in embodiments of this application.

In some implementations, in a case that the target aperiodic RS resource includes the target aperiodic SRS resource, the target aperiodic SRS resource is at least one aperiodic SRS resource in an aperiodic SRS resource set. It may be understood that the target aperiodic SRS resource is: one aperiodic SRS resource, two aperiodic SRS resources, a plurality of aperiodic SRS resources or all aperiodic SRS resources in the aperiodic SRS resource set. This is not limited in embodiments of this application.

In some implementations, in a case that the target aperiodic RS resource includes the target aperiodic SRS resource, the target aperiodic SRS resource is at least one enabled aperiodic SRS resource (of all aperiodic SRS resources) in an aperiodic SRS resource set.

For example, the foregoing step 202 and step 203 may specifically be implemented by using the following step 202a and step 203a.

Step 202a: The terminal transmits the target aperiodic SRS resource to the network-side device at the first slot position.

Step 203a: The network-side device receives the target aperiodic SRS resource from the terminal at the first slot position.

For example, in embodiments of this application, in a case that target information is RRC signaling, if the network-side device configures the first slot offset information in an aperiodic SRS set, all aperiodic SRS resources in the aperiodic SRS set share one piece of first slot offset information. If the network-side device configures the first slot offset information in an aperiodic SRS resource, one piece of first slot offset information is separately configured for each aperiodic SRS resource in the aperiodic SRS set. If the network-side device configures a plurality of pieces of first slot offset information in an aperiodic SRS set and each piece of first slot offset information corresponds to at least one aperiodic SRS resource, one piece of first slot offset information is configured for at least one aperiodic SRS resource in the aperiodic SRS set.

In some implementations, in a case that the target aperiodic RS resource includes the target aperiodic CSI-RS resource, the target aperiodic CSI-RS resource is: at least one aperiodic CSI-RS resource associated with an aperiodic CSI report. It may be understood that the target aperiodic CSI-RS resource is: one aperiodic CSI-RS resource, two aperiodic CSI-RS resources, a plurality of aperiodic CSI-RS resources or all aperiodic CSI-RS resources associated with the aperiodic CSI report.

In some implementations, in a case that the target aperiodic RS resource includes the target aperiodic CSI-RS resource, the target aperiodic CSI-RS resource is: at least one piece of enabled aperiodic CSI-RS resource (of all aperiodic CSI-RS resources) associated with an aperiodic CSI report.

For example, the foregoing step 202 and step 203 may specifically be implemented by using the following step 202b and step 203b.

Step 202b: The network-side device transmits the target aperiodic CSI-RS resource to the terminal at the first slot position.

Step 203b: The terminal receives the target aperiodic CSI-RS resource from the network-side device at the first slot position.

For example, in embodiments of this application, in a case that target information is RRC signaling, if the network-side device configures the first slot offset information in an aperiodic CSI report, all aperiodic CSI-RS resources associated with the aperiodic CSI report share one piece of first slot offset information. If the network-side device configures the first slot offset information in an aperiodic CSI resource, one piece of first slot offset information is separately configured for each CSI-RS resource associated with the aperiodic CSI report. If the network-side device configures a plurality of pieces of first slot offset information in an aperiodic CSI resource and each piece of first slot offset information corresponds to at least one aperiodic SRS resource associated with the aperiodic CSI report, one piece of first slot offset information is configured for at least one aperiodic SRS resource associated with the aperiodic CSI report.

In some implementations, the foregoing step 201 may be specifically implemented by using the following step 201c.

Step 201c: The terminal receives the target information.

The target information includes a slot offset indication field, and the slot offset indication field carries the first slot offset information; and the target information is at least one of the following: RRC signaling, DCI, and first Media Access Control Control Element (MAC CE) signaling. The target information may be other signaling. This is not limited in embodiments of this application.

Correspondingly, the network-side device transmits the target information.

In some implementations, the foregoing step 201a and step 201b may specifically be implemented by using the following step 201d and step 201e.

Step 202d. The terminal receives the target information from the network-side device.

Step 201e: The network-side device transmits the target information to the terminal.

For example, in embodiments of this application, the first slot offset information may be separately indicated by using one type of signaling, or the first slot offset information may be jointly indicated by using a plurality of types of signaling.

For example, in a case that the target information is the DCI or the first MAC CE signaling, the first slot offset information is one piece of slot offset information in a slot offset information set, and the slot offset information set is configured for the terminal through the RRC signaling or second MAC CE signaling.

It should be noted that, the foregoing first MAC CE signaling and second MAC CE signaling may be the same signaling or may be different signaling.

In some implementations, in a case that the slot offset information set is configured for the terminal through the second MAC CE signaling, the network-side device may update the slot offset information set through MAC CE signaling.

In some implementations, in a case that the slot offset information set is empty, the slot offset indication field has 0 bits.

In some implementations, before the foregoing step 202, the aperiodic RS transmission method provided in embodiments of this application may further include the following step 204 and step 205.

Step 204: The network-side device transmits target request information to the terminal.

Step 205: The terminal receives the target request information from the network-side device.

The target request information includes a target activation indication field, and the target activation indication field is for indicating whether to activate the target aperiodic RS resource. In a case that the target activation indication field does not exist or the target activation indication field indicates not to activate the target aperiodic RS resource, the slot offset indication field has 0 bits.

For example, in embodiments of this application, the foregoing target information and target request information may be the same signaling or may be different signaling. This is not limited in embodiments of this application.

For example, in a case that the target information is RRC signaling or MAC CE signaling, the target request information is DCI. When the target information is DCI, the target request information is also DCI. In this case, the target information and the target request information are two pieces of information carried in the same piece of DCI.

It may be understood that in a case that the target activation indication field does not exist (that is, the target activation indication field has 0 bits) or the target activation indication field indicates not to activate the target aperiodic RS resource (the value is 0 (that is, ‘0’ or ‘00’)), the slot offset indication field has 0 bits.

For example, the target activation indication field that is in DCI and that is for indicating whether to activate an aperiodic SRS resource is an SRS request field, in a case that the SRS request field has 0 bits or has a value of 0 (that is, ‘0’ or ‘00’), the slot offset indication field has 0 bits.

For example, the target activation indication field that is in DCI and that is for indicating whether to activate an aperiodic CSI-RS resource is a CSI request field, in a case that the CSI request field has 0 bits or has a value of 0 (that is, ‘0’ or ‘00’), the slot offset indication field has 0 bits.

It should be noted that, in embodiments of this application, in a case that the SRS request has two bits or three bits, and in a case that a cell in which the terminal is located does not support a Supplimentary UpLink (SUL), the SRS request has two bits. When a cell in which the terminal is located supports a SUL, the SRS request has three bits. The size of the CSI request is determined based on a higher layer parameter (reportTriggerSize). The CSI request may have m bits, where m is a natural number. For example, m is 0, 1, 2, 3, 4, 5, 6 or another value.

In embodiments of this application, the flexibility of setting a slot offset indication field is increased.

In some implementations, the target aperiodic RS resource is the target aperiodic SRS resource, the target request information is first request information, and the target activation indication field is a first activation indication field. When the first activation indication field indicates to activate the target aperiodic SRS resource, the first slot offset information is for indicating a first slot offset of the target aperiodic SRS resource.

For example, the foregoing step 204 and step 205 may specifically be implemented by using the following of step 204a and step 205a.

Step 204a: The network-side device transmits the first request information to the terminal.

Step 205a: The terminal receives the first request information from the network-side device.

The first request information includes a first activation indication field, and the first activation indication field is for indicating whether to activate the target aperiodic SRS resource. When the first activation indication field indicates to activate the target aperiodic SRS resource, the first slot offset information is for indicating a first slot offset of the target aperiodic SRS resource; and the target aperiodic RS resource is the target aperiodic SRS resource.

In some implementations, the target aperiodic RS resource is the target aperiodic CSI-RS resource, the target request information is second request information, and the target activation indication field is a second activation indication field. When the second activation indication field indicates to activate the target aperiodic CSI-RS resource, the first slot offset information is for indicating a first slot offset of the target aperiodic CSI-RS resource.

For example, the foregoing step 204 and step 205 may specifically be implemented by using the following step 204b and step 205b.

Step 204b: The network-side device transmits the second request information to the terminal.

Step 205b: The terminal receives the second request information from the network-side device.

The second request information includes a second activation indication field, and the second activation indication field is for indicating whether to activate the target aperiodic CSI-RS resource. When the second activation indication field indicates to activate the target aperiodic CSI-RS resource, the first slot offset information is for indicating a first slot offset of the target aperiodic CSI-RS resource; and the target aperiodic RS resource is the target aperiodic CSI-RS resource.

In embodiments of this application, in a case that it is set that the SRS request field indicates to activate an SRS resource, the first slot offset information is for indicating the first slot offset of the target aperiodic SRS resource. When the CSI request field indicates to activate a CSI-RS resource, the first slot offset information is for indicating the first slot offset of the target aperiodic CSI-RS resource, so that the flexibility and versatility of indicating the first slot offset information can be increased.

For example, in embodiments of this application, the slot offset indication field may be one indication field, or may be two indication fields, or may be another feasible case. This is not limited in embodiments of this application.

For example, the slot offset indication field includes at least one of the following: a first indication field and a second indication field.

The first indication field is for carrying first offset information, and the first offset information is for indicating a first slot offset of an aperiodic SRS resource; and the second indication field is for carrying second offset information, and the second offset information is for indicating a first slot offset of an aperiodic CSI-RS.

It should be noted that for description of the foregoing first indication field and second indication field, refer to the foregoing related description of indicating a slot offset. Details are not described herein again. For description of the foregoing first offset information and second offset information, refer to the foregoing related description of the first slot offset information. Details are not described herein again.

It may be understood that in a case that the slot offset indication field is one indication field, there are three cases as follows:

In a first case, the slot offset indication field is only used for an aperiodic SRS resource. In this case, the slot offset indication field is the first indication field, and the first offset information (that is, the first slot offset information) is for indicating the first slot offset of the aperiodic SRS resource.

In a second case, the slot offset indication field is only used for an aperiodic CSI-RS resource. In this case, the slot offset indication field is the second indication field, and the second offset information (that is, the first slot offset information) is for indicating the first slot offset of the aperiodic CSI-RS resource.

In a third case, the slot offset indication field is used for an aperiodic SRS resource and an aperiodic CSI-RS resource (the aperiodic SRS resource and the aperiodic CSI-RS resource share one indication field). In this case, the slot offset indication field is the first indication field and the second indication field, the first indication field and the second indication field are the same indication field, and the first offset information and the second offset information are the same piece of offset information (that is, the first slot offset information). Further, the first slot offset information may be for indicating the first slot offset of the aperiodic SRS resource and may also be for indicating the first slot offset of the aperiodic CSI-RS resource.

It may be understood that the foregoing third case may specifically include three cases as follows:

1. The first slot offset information simultaneously indicates the first slot offset of the aperiodic SRS resource and the first slot offset of the aperiodic CSI-RS resource.

2. When the SRS request field is not 0 (that is, the SRS request field indicates to activate an aperiodic SRS resource), the first slot offset information indicates the first slot offset of the aperiodic SRS resource.

3. When the CSI request field is not 0 (that is, the CSI request field indicates to activate an aperiodic CSI-RS resource), the first slot offset information indicates the first slot offset of the aperiodic CSI-RS.

It may be understood that in a case that the slot offset indication field is two indication fields, one indication field is used for an aperiodic SRS resource (that is, the first indication field is used for an aperiodic SRS resource), and the other indication field is used for an aperiodic CSI-RS resource (that is, the first indication field is used for an aperiodic CSI-RS resource).

In embodiments of this application, a plurality of possible existence forms the slot offset indication field are added.

In some implementations, the first slot offset information includes offsetting N target slots, any target slot is any one of the following: an uplink slot, a downlink slot, a special slot, a valid slot, an enable slot, and a random slot, and N is a natural number.

It should be noted that, in embodiments of this application, a sequential order of offsetting based on the first offset information and offsetting based on the second slot offset is not limited. For example, a communication device (after receiving DCI for activating the target aperiodic RS resource) may first perform offsetting based on the second slot offset and then perform offsetting based on the first offset information to determine the first slot position; or may first perform offsetting based on the first offset information and then perform offsetting based on the second slot offset to determine the first slot position.

It may be understood that, in embodiments of this application, the offsetting N target slots is offsetting to an Nth target slot.

In some implementations, in a case that the first slot position is determined through the first slot offset, the target slot is an uplink slot, a downlink slot, a special slot, a valid slot, or an enable slot. That is, the first slot offset information includes offsetting N uplink slots, N downlink slots, N special slots, N enable slots or N valid slots.

In embodiments of this application, in a case that the first slot position is determined through the first slot offset, the first slot offset information is offsetting N target slots, and compared with the solution that the first slot position is determined from the second slot offset in the related technology, a manner of determining the transmission or reception slot position of the aperiodic RS resource is more flexible, so that aperiodic RS resource can be better transmitted or received. In addition, a manner of determining and delivering a slot position of DCI for activating the aperiodic RS resource is also more flexible, that is, a manner of determining a slot position for transmitting a PDCCH is more flexible.

In some implementations, in a case that the first slot offset information is not configured, N is a default value. The default value may be a preset random value, and may be specifically determined according to an actual use requirement. This is not limited in embodiments of this application.

For example, in a case that the slot offset indication field associated with an aperiodic SRS or an aperiodic CSI-RS is not configured (that is, the first slot offset information is not configured), N is 0 or 1, that is, the first slot offset information is offsetting zero target slots or offsetting one target slot, that is, offset to the zeroth target slot or offset to the first target slot.

For example, in a case that the target information is DCI, if the slot offset indication field has one bit (that is, the value of the slot offset indication field is ‘0’ or ‘1’), the first slot offset information may be offset to the first target slot or offset to the second target slot, or the first slot offset information may be offset to the zeroth target slot or offset to the first target slot.

For example, in a case that the target information is DCI, if the slot offset indication field has two bits (that is, the value of the slot offset indication field is ‘00’, ‘01’, ‘10’, or ‘11’), the first slot offset information may be offset to the first target slot, offset to the second target slot, offset to the third target slot, or offset to the fourth target slot, or the first slot offset information may be offset to the zeroth target slot, offset to the first target slot, offset to the second target slot, or offset to the third target slot.

For example, in a case that the target aperiodic RS resource is an aperiodic SRS resource, the target slot may include an uplink slot and a special slot usable for uplink transmission. When the target aperiodic RS resource is an aperiodic CSI-RS resource, the target slot may include a downlink slot and a special slot usable for downlink transmission.

In embodiments of this application, the random slot refers to a random time unit on a slot resource, and the offsetting N random slots refers to offsetting N consecutive slots.

In embodiments of this application, for the description of the foregoing uplink slot, downlink slot, special slot, valid slot, and enable slot, refer to the description in the related technology. Details are not described herein again.

In some implementations, the valid slot is a slot resource usable for transmitting the target aperiodic RS resource. It may be understood that the valid slot is a slot resource usable for transmitting all symbol resources in the target aperiodic RS resource.

For example, in a case that the target aperiodic RS resource is the target aperiodic SRS resource, the valid slot is a slot resource usable for transmitting all symbol resources in the target aperiodic SRS resource. The target aperiodic SRS resource is at least one aperiodic SRS resource in the aperiodic SRS resource set.

For example, in a case that the target aperiodic RS resource is the target aperiodic CSI-RS resource, the valid slot is a slot resource usable for transmitting all symbol resources in the target aperiodic CSI-RS resource. The target aperiodic CSI-RS resource is at least one aperiodic CSI-RS resource associated with the aperiodic CSI report.

Further, the valid slot is a slot resource that is in a valid window and that is usable for transmitting the target aperiodic RS resource. For description of the valid window, refer to the following description of the valid window. Details are not described herein again.

In some implementations, the first slot position satisfies at least one of the following: the first slot position is located in a valid window; a time interval between the first slot position and second slot position is longer than or equal to a first time interval; and a time interval between aperiodic RS resources in the target aperiodic RS resource is longer than or equal to a minimum time interval of antenna switching, where the second slot position is a slot position at which DCI for activating the target aperiodic RS resource is received, and the first time interval is a minimum time interval between DCI for activating an aperiodic RS resource and the aperiodic RS resource.

It may be understood that in a case that the first slot position is located in the valid window, the first slot position may be a random slot in the valid window, or the first slot position may be an enable slot in the valid window.

In some implementations, the valid window is determined by at least one of the following: configured by the network-side device, specified in a protocol, and reported by the terminal. It may be understood that the valid window is determined by at least one of: configured by the network-side device, specified in a protocol, and reported by the terminal, or the valid window is jointly determined by a plurality of the following: configured by the network-side device, specified in a protocol, and reported by the terminal. This may be specifically determined according to an actual use requirement.

In some implementations, a slot template of the valid window is determined by at least one of the following: configured by the network-side device, specified in a protocol, and reported by the terminal. It may be understood that the slot template of the valid window is determined by at least one of: configured by the network-side device, specified in a protocol, and reported by the terminal, or the slot template of the valid window is jointly determined by a plurality of the following: configured by the network-side device, specified in a protocol, and reported by the terminal. This may be specifically determined according to an actual use requirement.

In some implementations, the slot template includes a starting point of the valid window, a window size of the valid window, and a distribution of slots in the valid window. The distribution of slots in the valid window refers to a distribution of uplink slots, downlink slots, special slots, valid slots, enable slots, and the like in the valid window.

In some implementations, the slot template includes a starting point of the valid window, a window size of the valid window, and a position distribution of enable slots in the valid window.

It may be understood that the valid window may be consecutive slot windows, that is, the enable slots in the valid window are consecutive. The valid window may be nonconsecutive slot windows, that is, the enable slots in the valid window are not consecutive.

In some implementations, in a case that the first slot position is an enable slot in the valid window, the terminal (or the network-side device) transmits or receives the target aperiodic RS resource at the first slot position. When the first slot position is a slot position other than four enable slots, the terminal (or the network-side device) may not transmit or receive the target aperiodic RS resource.

For example, the starting point of the valid window may be specified in a protocol. The window size of the valid window may be determined by any of the following: configured by the network-side device, specified in a protocol, reported by the terminal. The position distribution of the enable slots in the valid window is configured by the network-side device.

In some implementations, the starting point of the valid window is located in the second slot position or a third slot position. The third slot position is a slot position determined after the second slot position is offset by the second slot offset. The starting point of the valid window may be located at another slot position. This is not limited in embodiments of this application.

In some implementations, the window size of the valid window may be infinitely long, that is, it is equivalent to that there is no valid window.

For example, the slot template is 1000100101. The window size of the valid window is 10 slots, and may be configured by a network or reported by the terminal by using an indication method such as a bitmap. Slots whose positions are indicated by 1 are the position distribution of the enable slots in the valid window. When the enable slots in the valid window are target slots, the first slot offset information being offset to the first enable slot in the valid window refers to offsetting to a slot position indicated by the first 1. Similarly, the first slot offset information being offset to the second enable slot in the valid window refers to being offset to a slot position indicated by the second 1.

For example, the slot template may be determined based on whether the activated target aperiodic RS resource is an uplink resource or a downlink resource. If the activated target aperiodic RS resource is an uplink resource, the slot template may include only a slot resource usable for uplink transmission, and/or, if the activated target aperiodic RS resource includes an uplink resource, the slot template may include only a slot resource usable for downlink transmission.

In some implementations, in a case that the first slot position is determined through the first slot offset and the second slot offset, if the DCI for activating the target aperiodic RS resource is received in the slot n, the target aperiodic RS resource is transmitted in a slot m, where a calculation formula is as follows:

When ca-slotoffset is configured for a target aperiodic RS resource in an activated cell,

$$m = ( n \cdot \frac{{2}^{{μ}_{RS}}}{{2}^{{μ}_{PDCCH}}} ) + t + [ ( \frac{{N}_{slot , offset , PDCCH}^{CA}}{{2}^{{μ}_{offset , PDCCH}}} - \frac{{N}_{slot , offset , RS}^{CA}}{{2}^{{μ}_{offset , RS}}} ) \cdot {2}^{{μ}_{RS}} ] + f ( {t}_{s} ) .$$

In other cases,

$$m = ( n \cdot \frac{{2}^{{μ}_{RS}}}{{2}^{{μ}_{PDCCH}}} ) + t + f ( {t}_{s} ) .$$

t represents a slot offset (the second slot offset) of the target aperiodic RS resource configured by RRC, f(t) represents the first slot offset indicated by the first slot offset information, and the foregoing formula is further related to a SubCarrier Spacing (SCS) of a PDCCH carrying DCI, and an SCS of the target aperiodic RS resource.

For example, in a case that the target aperiodic RS resource is the target aperiodic SRS resource, the foregoing calculation formula is as follows:

When ca-slotoffset is configured for a target aperiodic SRS resource in an activated cell,

$$m = ( n \cdot \frac{{2}^{{μ}_{SRS}}}{{2}^{{μ}_{PDCCH}}} ) + t + [ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ] + f ( {t}_{s} )$$

In other cases,

$$m = ( n \cdot \frac{{2}^{{μ}_{SRS}}}{{2}^{{μ}_{PDCCH}}} ) + t + f ( {t}_{s} ) .$$

t represents a slot offset (the second slot offset) of the target aperiodic SRS resource configured by RRC, and f(t) represents the first slot offset of the target aperiodic SRS resource indicated by the first slot offset information.

For example, in a case that the target aperiodic RS resource is the target aperiodic CSI-RS resource, the foregoing calculation formula is as follows:

When ca-slotoffset is configured for an aperiodic CSI-RS resource in an activated cell,

$$m = ( n \cdot \frac{{2}^{{μ}_{CSIRS}}}{{2}^{{μ}_{PDCCH}}} ) + t + [ ( \frac{{N}_{slot , offset , PDCCH}^{CA}}{{2}^{{μ}_{offset , PDCCH}}} - \frac{{N}_{slot , offset , CSIRS}^{CA}}{{2}^{{μ}_{offset , CSIRS}}} ) \cdot {2}^{{μ}_{CSIRS}} ] + f ( {t}_{s} )$$

In other cases,

$$m = ( n \cdot \frac{{2}^{{μ}_{CSIRS}}}{{2}^{{μ}_{PDCCH}}} ) + t + f ( {t}_{s} ) .$$

t represents a slot offset (the second slot offset) of the target aperiodic CSI-RS resource configured by RRC, and f(t) represents the first slot offset of the target aperiodic CSI-RS resource indicated by the first slot offset information.

For example, the DCI or the RRC signaling is separately indicated. For example, the first slot offset information is added to the DCI or the RRC signaling. The aperiodic SRS resource set includes one aperiodic SRS resource. The second slot offset configured by the RRC for the aperiodic SRS resource set is offsetting three slots. The DCI is transmitted in the slot n.

When the first slot offset information in the DCI or the RRC is offsetting one valid slot, the aperiodic SRS resource is transmitted in a slot n+4, as shown in Table 1.

TABLE 1

| D | D | U | D | U | D | U | D | U | D | D |
|---|---|---|---|---|---|---|---|---|---|---|
| slot n | slot | slot | slot | slot | slot | slot | slot | slot | slot | slot |
| | n + 1 | n + 2 | n + 3 | n + 4 | n + 5 | n + 6 | n + 7 | n + 8 | n + 9 | n + 10 |
| PDCCH | | | | SRS | | | | | | |

When the first slot offset information in the DCI or the RRC is offsetting one valid slot, aperiodic SRS resource is transmitted in a slot n+6, as shown in Table 2.

TABLE 2

| D | D | U | D | U | D | U | D | U | D | D |
|---|---|---|---|---|---|---|---|---|---|---|
| slot n | slot | slot | slot | slot | slot | slot | slot | slot | slot | slot |
| | n + 1 | n + 2 | n + 3 | n + 4 | n + 5 | n + 6 | n + 7 | n + 8 | n + 9 | n + 10 |
| PDCCH | | | | | | SRS | | | | |

For example, a plurality of pieces of signaling are jointly indicated. For example, the slot offset information set is configured in RRC. The DCI indicates that the first slot offset information is one piece of information in the slot offset information set. The aperiodic SRS resource set includes one aperiodic SRS resource. The second slot offset configured by the RRC for the aperiodic SRS resource set is offsetting three slots. The DCI is transmitted in the slot n. The slot offset information set configured in the RRC is {1, 2, 3, 6}, which respectively represent offsetting one valid slot, offsetting two valid slots, offsetting three valid slots, and offsetting six valid slots.

When the DCI indicates that the first slot offset information is the first value in the slot offset information set, the aperiodic SRS resource is transmitted in the slot n+4, as shown in Table 3.

TABLE 3

| D | D | U | D | U | D | U | D | U | D | D |
|---|---|---|---|---|---|---|---|---|---|---|
| slot n | slot | slot | slot | slot | slot | slot | slot | slot | slot | slot |
| | n + 1 | n + 2 | n + 3 | n + 4 | n + 5 | n + 6 | n + 7 | n + 8 | n + 9 | n + 10 |
| PDCCH | | | | SRS | | | | | | |

When the DCI indicates that the first slot offset information is the second value in the slot offset information set, the aperiodic SRS resource is transmitted in the slot n+6, as shown in Table

TABLE 4

| D | D | U | D | U | D | U | D | U | D | D |
|---|---|---|---|---|---|---|---|---|---|---|
| slot n | slot | slot | slot | slot | slot | slot | slot | slot | slot | slot |
| | n + 1 | n + 2 | n + 3 | n + 4 | n + 5 | n + 6 | n + 7 | n + 8 | n + 9 | n + 10 |
| PDCCH | | | | | | SRS | | | | |

When the DCI indicates that the first slot offset information is the third value in the slot offset information set, the aperiodic SRS resource is transmitted in the slot n+8, as shown in Table 5.

TABLE 5

| D | D | U | D | U | D | U | D | U | D | D |
|---|---|---|---|---|---|---|---|---|---|---|
| slot n | slot | slot | slot | slot | slot | slot | slot | slot | slot | slot |
| | n + 1 | n + 2 | n + 3 | n + 4 | n + 5 | n + 6 | n + 7 | n + 8 | n + 9 | n + 10 |
| PDCCH | | | | | | | | SRS | | |

It should be noted that, in the foregoing examples, D denotes a downlink slot, U denotes an uplink slot, and for an aperiodic SRS resource, the uplink slot is a valid slot.

In embodiments of this application, a terminal receives first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource. In the solution, the solution of determining a first slot position through a first slot offset or determining a first slot position through a first slot offset and a second slot offset increases the selectability and flexibility of determining a slot position for the terminal to transmit or receive an aperiodic RS resource, so that the problem that a manner of determining a slot position for the terminal to transmit or receive an aperiodic RS resource is not flexible enough in the related technology can be solved. In addition, the solution increases the selectability and flexibility of delivering a slot position of DCI for activating the aperiodic RS resource, that is, increases the selectability and flexibility of a slot position for transmitting a PDCCH, and can resolve to a certain extent the problem of congestion of PDCCH resources caused by delivery of a plurality of pieces of DCI in the same slot in the related technology.

It should be noted that the aperiodic RS transmission method provided in embodiments of this application may be performed by an aperiodic RS transmission apparatus, or a control module configured to perform the aperiodic RS transmission method in the aperiodic RS transmission apparatus. In embodiments of this application, an example in which the aperiodic RS transmission apparatus performs the aperiodic RS transmission method is used to describe the aperiodic RS transmission apparatus provided in embodiments of this application.

FIG. 3 is a schematic diagram of a structure of an aperiodic RS transmission apparatus according to an embodiment of this application. As shown in FIG. 3, an aperiodic RS transmission 300 may include: a receiving module 301, configured to receive first slot offset information, where the first slot offset information is for indicating a first slot offset of a target aperiodic RS resource; and a transceiver module 302, configured to transmit or receive the target aperiodic RS resource at a first slot position, where the first slot position is determined from any of the following: the first slot offset, and the first slot offset and a second slot offset; and the second slot offset is a slot offset configured for the target aperiodic RS resource.

In some implementations, the receiving module 301 is specifically configured to receive target information, where the target information includes a slot offset indication field, and the slot offset indication field carries the first slot offset information; and the target information is at least one of the following: RRC signaling, DCI, and first MAC CE signaling.

In some implementations, in a case that the target information is the DCI or the first MAC CE signaling, the first slot offset information is one piece of slot offset information in a slot offset information set, and the slot offset information set is configured for a terminal through the RRC signaling or second MAC CE signaling.

In some implementations, in a case that the slot offset information set is empty, the slot offset indication field has 0 bits.

In some implementations, the slot offset indication field includes at least one of the following: a first indication field and a second indication field, where the first indication field is for carrying first offset information, and the first offset information is for indicating a first slot offset of an aperiodic sounding reference signal SRS resource; and the second indication field is for carrying second offset information, and the second offset information is for indicating a first slot offset of an aperiodic CSI-RS.

In some implementations, the receiving module 301 is configured to: before the target aperiodic RS resource is transmitted or received at the first slot position, receive target request information, where the target request information includes a target activation indication field, and the target activation indication field is for indicating whether to activate the target aperiodic RS resource; and in a case that the target activation indication field does not exist or the target activation indication field indicates not to activate the target aperiodic RS resource, the slot offset indication field has 0 bits.

In some implementations, the target aperiodic RS resource includes at least one of the following: a target aperiodic SRS resource and a target aperiodic CSI-RS resource.

In some implementations, in a case that the target aperiodic RS resource includes the target aperiodic SRS resource, the target aperiodic SRS resource is at least one aperiodic SRS resource in an aperiodic SRS resource set; and in a case that the target aperiodic RS resource includes the target aperiodic CSI-RS resource, the target aperiodic CSI-RS resource is at least one aperiodic CSI-RS resource associated with an aperiodic CSI report.

In some implementations, the receiving module 301 is configured to: before the target aperiodic RS resource is transmitted or received at the first slot position, receive first request information, where the first request information includes a first activation indication field, and the first activation indication field is for indicating whether to activate the target aperiodic SRS resource; in a case that the first activation indication field indicates to activate the target aperiodic SRS resource, the first slot offset information is for indicating a first slot offset of the target aperiodic SRS resource; and the target aperiodic RS resource is the target aperiodic SRS resource.

In some implementations, the receiving module 301 is configured to: before the target aperiodic RS resource is transmitted or received at the first slot position, receive second request information, where the second request information includes a second activation indication field, and the second activation indication field is for indicating whether to activate the target aperiodic CSI-RS resource: in a case that the second activation indication field indicates to activate the target aperiodic CSI-RS resource, the first slot offset information is for indicating a first slot offset of the target aperiodic CSI-RS resource: and the target aperiodic RS resource is the target aperiodic CSI-RS resource.

In some implementations, the first slot offset information includes offsetting N target slots, any target slot is any one of the following: an uplink slot, a downlink slot, a special slot, a valid slot, an enable slot, and a random slot, and N is a natural number.

In some implementations, in a case that the first slot offset information is not configured, N is a default value.

In some implementations, the valid slot is a slot resource usable for transmitting the target aperiodic RS resource.

In some implementations, the first slot position satisfies at least one of the following: the first slot position is located in a valid window; a time interval between the first slot position and second slot position is longer than or equal to a first time interval; and a time interval between aperiodic RS resources in the target aperiodic RS resource is longer than or equal to a minimum time interval of antenna switching, where the second slot position is a slot position at which DCI for activating the target aperiodic RS resource is received, and the first time interval is a minimum time interval between DCI for activating an aperiodic RS resource and the aperiodic RS resource.

In some implementations, the valid window is determined by at least one of the following: configured by the network-side device, specified in a protocol, and reported by a terminal.

In some implementations, a slot template of the valid window is determined by at least one of the following: configured by the network-side device, specified in a protocol, and reported by a terminal, where the slot template includes a starting point of the valid window, a window size of the valid window, and a position distribution of enable slots in the valid window.

In some implementations, the starting point of the valid window is located in the second slot position or a third slot position. The third slot position is a slot position determined after the second slot position is offset by the second slot offset.

In embodiments of this application, a terminal receives first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource. In the solution, the solution of determining a first slot position through a first slot offset or determining a first slot position through a first slot offset and a second slot offset increases the selectability and flexibility of determining a slot position for the terminal to transmit or receive an aperiodic RS resource, so that the problem that a manner of determining a slot position for the terminal to transmit or receive an aperiodic RS resource is not flexible enough in the related technology can be solved. In addition, the solution increases the selectability and flexibility of delivering a slot position of DCI for activating the aperiodic RS resource, that is, increases the selectability and flexibility of a slot position for transmitting a PDCCH, and can resolve to a certain extent the problem of congestion of PDCCH resources caused by delivery of a plurality of pieces of DCI in the same slot in the related technology.

The aperiodic RS transmission apparatus in embodiments of this application may be an apparatus or may be a part, an integrated circuit or a chip in a terminal. The apparatus may be a mobile terminal or may be a non-mobile terminal. For example, the mobile terminal may include, but is not limited to, the type of the terminal 11 listed above. The non-mobile terminal may be a server, a Network Attached Storage (NAS), a personal computer, a television, a teller machine, a kiosk, or the like. This is not specifically limited in embodiments of this application.

The aperiodic RS transmission apparatus in embodiments of this application may be an apparatus with an operating system. The operating system may be an Android operating system, may be an iOS operating system, or may be another possible operating system. This is not specifically limited in embodiments of this application.

The aperiodic RS transmission apparatus provided in embodiments of this application can implement each process implemented in the method embodiments in FIG. 2, and the same technical effect can be achieved. To avoid repetition, details are not described herein again.

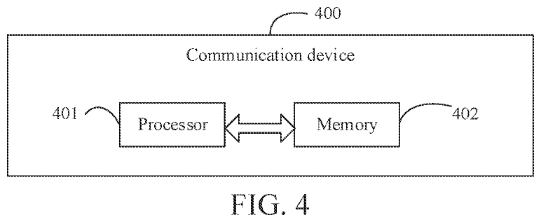

In some implementations, as shown in FIG. 4, embodiments of this application further provide a communication device 400, including a processor 401, a memory 402, and a program or instructions stored in the memory 402 and runnable on the processor 401. For example, when the communication device 400 is a terminal, the program or instructions, when being executed by the processor 401, implement each process in embodiments of the foregoing aperiodic RS transmission method, and the same technical effect can be achieved. When the communication device 400 is a network-side device, the program or instructions, when being executed by the processor 401, implement each process in embodiments of the foregoing aperiodic RS transmission method, and the same technical effect can be achieved. To avoid repetition, details are not described herein again.

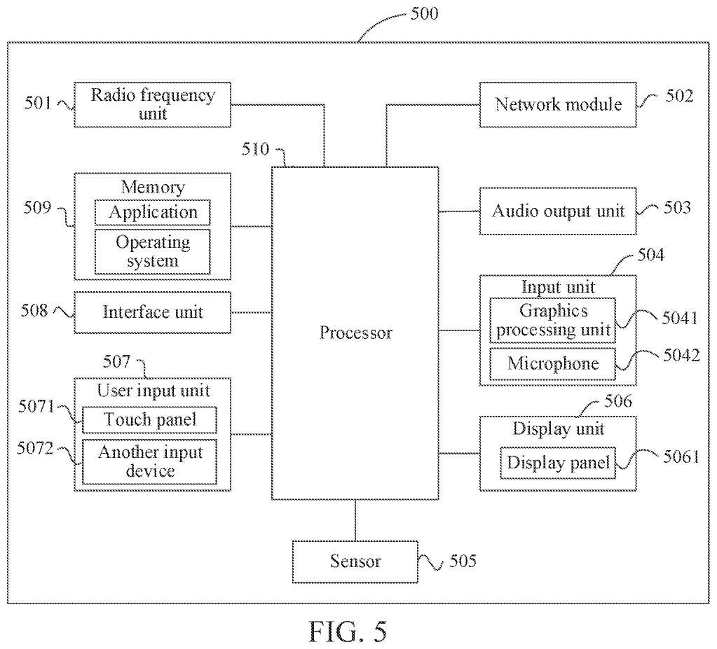

FIG. 5 is a schematic diagram of a hardware structure of a terminal according to an embodiment of this application.

A terminal 500 includes, but is not limited to, components such as a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (such as a battery) for supplying power to the components. The power supply may be logically connected to the processor 510 by a power management system, thereby implementing functions such as charging discharging, and power consumption management by using the power management system. A person skilled in the art may understand that the terminal structure shown in FIG. 5 does not constitute a limitation on the terminal, and the terminal may include more or fewer components than shown, or combine some components, or have different component arrangements. Details are not described herein again.

It should be understood that in embodiments of this application, the input unit 504 may include a Graphics Processing Unit (GPU) 5041 and a microphone 5042. The graphics processing unit 5041 performs processing on image data of a static picture or a video that is obtained by an image acquisition device (for example, a camera) in a video acquisition mode or an image acquisition mode. The display unit 506 may include a display panel 5061. The display panel 5061 may be configured in the form of a liquid crystal display, an organic light-emitting diode, or the like. The user input unit 507 includes a touch panel 5071 and another input device 5072. The touch panel 5071 may be referred to as a touch screen. The touch panel 5071 may include two parts: a touch detection apparatus and a touch controller. The another input device 5072 may include, but not limited to, a physical keyboard, a functional key (such as a volume control key or a switch key), a track ball, a mouse, and a joystick, which are not described herein in detail.

In embodiments of this application, the radio frequency unit 501 receives downlink data from a network-side device, and then delivers the downlink data to the processor 510 for processing; and in addition, sends uplink data to the network-side device. Generally, the radio frequency unit 501 includes, but is not limited to, an antenna, at least one amplifier, a transceiver, a coupler, a low noise amplifier, a duplexer, and the like.

The memory 509 may be configured to store a software program or instructions and various data. The memory 509 may mainly include a program storage or instruction area and a data storage area. The program storage or instruction area may store an operating system, an application or instructions required by at least one function (for example, a sound playback function and an image display function), and the like. In addition, the memory 509 may include a high speed random access memory, and may further include a non-volatile memory. The non-volatile memory may be a Read-Only Memory (ROM), a Programmable ROM (PROM), an Erasable Programmable Read-Only Memory (EPROM), an Electrically EPROM (EEPROM), or a flash memory, and is, for example, at least one magnetic disk storage device, a flash memory or another non-volatile solid-state storage device.

The processor 510 may include one or more processing units. In some implementations, the processor 510 may integrate an application processor and a modem processor. The application processor mainly processes an operating system, a user interface, an application, instructions, or the like. The modem processor mainly processes wireless communication, and is, for example, a baseband processor. It may be understood that the modem processor may alternatively not be integrated in the processor 510.

The radio frequency unit 501 is configured to receive first slot offset information, where the first slot offset information is for indicating a first slot offset of a target aperiodic RS resource; and is configured to transmit or receive the target aperiodic RS resource at a first slot position, where the first slot position is determined from any of the following: the first slot offset, and the first slot offset and a second slot offset; and the second slot offset is a slot offset configured for the target aperiodic RS resource.

In some implementations, the radio frequency unit 501 is specifically configured to receive target information, where the target information includes a slot offset indication field, and the slot offset indication field carries the first slot offset information; and the target information is at least one of the following: RRC signaling, DCI, and first MAC CE signaling.

In some implementations, in a case that the target information is the DCI or the first MAC CE signaling, the first slot offset information is one piece of slot offset information in a slot offset information set, and the slot offset information set is configured for the terminal through the RRC signaling or second MAC CE signaling.

In some implementations, in a case that the slot offset information set is empty, the slot offset indication field has 0 bits.

In some implementations, the slot offset indication field includes at least one of the following: a first indication field and a second indication field, where the first indication field is for carrying first offset information, and the first offset information is for indicating a first slot offset of an aperiodic sounding reference signal SRS resource; and the second indication field is for carrying second offset information, and the second offset information is for indicating a first slot offset of an aperiodic channel state information reference signal CSI-RS.

In some implementations, the radio frequency unit 501 is configured to: before the target aperiodic RS resource is transmitted or received at the first slot position, receive target request information, where the target request information includes a target activation indication field, and the target activation indication field is for indicating whether to activate the target aperiodic RS resource; and in a case that the target activation indication field does not exist or the target activation indication field indicates not to activate the target aperiodic RS resource, the slot offset indication field has 0 bits.

In some implementations, the target aperiodic RS resource includes at least one of the following: a target aperiodic SRS resource and a target aperiodic CSI-RS resource.

In some implementations, in a case that the target aperiodic RS resource includes the target aperiodic SRS resource, the target aperiodic SRS resource is at least one aperiodic SRS resource in an aperiodic SRS resource set; and in a case that the target aperiodic RS resource includes the target aperiodic CSI-RS resource, the target aperiodic CSI-RS resource is at least one aperiodic CSI-RS resource associated with an aperiodic CSI report.

In some implementations, the radio frequency unit 501 is configured to: before the target aperiodic RS resource is transmitted or received at the first slot position, receive first request information, where the first request information includes a first activation indication field, and the first activation indication field is for indicating whether to activate the target aperiodic SRS resource; in a case that the first activation indication field indicates to activate the target aperiodic SRS resource, the first slot offset information is for indicating a first slot offset of the target aperiodic SRS resource; and the target aperiodic RS resource is the target aperiodic SRS resource.

In some implementations, the radio frequency unit 501 is configured to: before the target aperiodic RS resource is transmitted or received at the first slot position, receive second request information, where the second request information includes a second activation indication field, and the second activation indication field is for indicating whether to activate the target aperiodic CSI-RS resource; in a case that the second activation indication field indicates to activate the target aperiodic CSI-RS resource, the first slot offset information is for indicating a first slot offset of the target aperiodic CSI-RS resource; and the target aperiodic RS resource is the target aperiodic CSI-RS resource.

In some implementations, the first slot offset information includes offsetting N target slots, any target slot is any one of the following: an uplink slot, a downlink slot, a special slot, a valid slot, an enable slot, and a random slot, and N is a natural number.

In some implementations, in a case that the first slot offset information is not configured, N is a default value.

In some implementations, the valid slot is a slot resource usable for transmitting the target aperiodic RS resource.

In some implementations, the first slot position satisfies at least one of the following: the first slot position is located in a valid window; a time interval between the first slot position and second slot position is longer than or equal to a first time interval; and a time interval between aperiodic RS resources in the target aperiodic RS resource is longer than or equal to a minimum time interval of antenna switching, where the second slot position is a slot position at which DCI for activating the target aperiodic RS resource is received, and the first time interval is a minimum time interval between DCI for activating an aperiodic RS resource and the aperiodic RS resource.

In some implementations, the valid window is determined by at least one of the following: configured by the network-side device, specified in a protocol, and reported by a terminal.

In some implementations, a slot template of the valid window is determined by at least one of the following: configured by the network-side device, specified in a protocol, and reported by a terminal, where the slot template includes a starting point of the valid window, a window size of the valid window, and a position distribution of enable slots in the valid window.

In some implementations, the starting point of the valid window is located in the second slot position or a third slot position. The third slot position is a slot position determined after the second slot position is offset by the second slot offset.

In embodiments of this application, a terminal receives first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource. In the solution, the solution of determining a first slot position through a first slot offset or determining a first slot position through a first slot offset and a second slot offset increases the selectability and flexibility of determining a slot position for the terminal to transmit or receive an aperiodic RS resource, so that the problem that a manner of determining a slot position for the terminal to transmit or receive an aperiodic RS resource is not flexible enough in the related technology can be solved. In addition, the solution increases the selectability and flexibility of delivering a slot position of DCI for activating the aperiodic RS resource, that is, increases the selectability and flexibility of a slot position for transmitting a PDCCH, and can resolve to a certain extent the problem of congestion of PDCCH resources caused by delivery of a plurality of pieces of DCI in the same slot in the related technology.

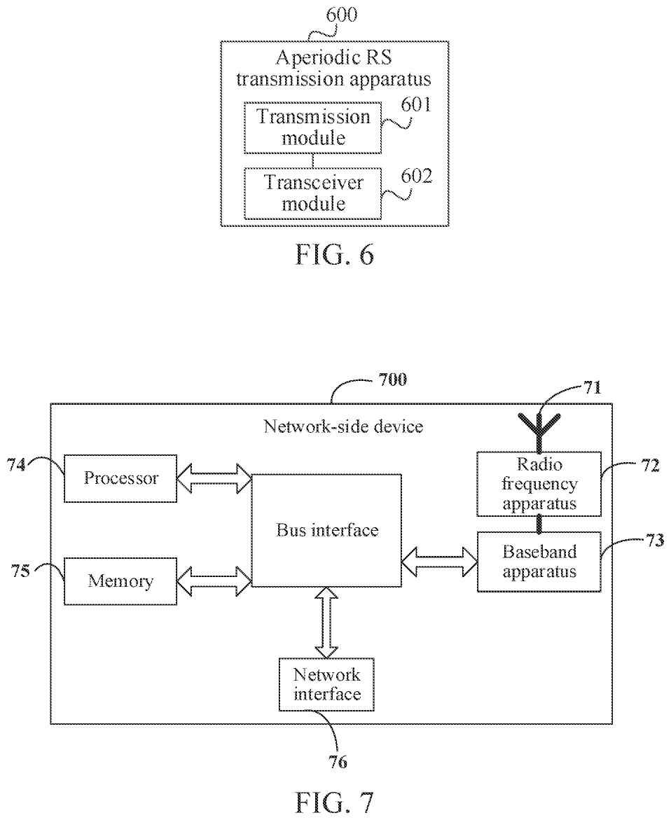

FIG. 6 is a schematic diagram of a structure of an aperiodic RS transmission apparatus according to an embodiment of this application. As shown in FIG. 6, an aperiodic RS transmission apparatus 600 may include: a transmission module 601, configured to transmit first slot offset information, where the first slot offset information is for indicating a first slot offset of a target aperiodic RS resource; and a transceiver module 602, configured to transmit or receive the target aperiodic RS resource at a first slot position, where the first slot position is determined from any of the following: the first slot offset, and the first slot offset and a second slot offset; and the second slot offset is a slot offset configured for the target aperiodic RS resource.

In some implementations, the transmission module 601 is specifically configured to transmit target information, where the target information includes a slot offset indication field, and the slot offset indication field carries the first slot offset information; and the target information is at least one of the following: RRC signaling, DCI, and first MAC CE signaling.

In some implementations, in a case that the target information is the DCI or the first MAC CE signaling, the first slot offset information is one piece of slot offset information in a slot offset information set, and the slot offset information set is configured for a terminal through the RRC signaling or second MAC CE signaling.

In some implementations, in a case that the slot offset information set is empty, the slot offset indication field has 0 bits.

In some implementations, the slot offset indication field includes at least one of the following: a first indication field and a second indication field,

where the first indication field is for carrying first offset information, and the first offset information is for indicating a first slot offset of an aperiodic sounding reference signal SRS resource; and the second indication field is for carrying second offset information, and the second offset information is for indicating a first slot offset of an aperiodic channel state information reference signal CSI-RS.

In some implementations, the transmission module 601 is configured to: before the target aperiodic RS resource is transmitted or received at the first slot position, transmit target request information, where the target request information includes a target activation indication field, and the target activation indication field is for indicating whether to activate the target aperiodic RS resource; and in a case that the target activation indication field does not exist or the target activation indication field indicates not to activate the target aperiodic RS resource, the slot offset indication field has 0 bits.

In some implementations, the target aperiodic RS resource includes at least one of the following: a target aperiodic SRS resource and a target aperiodic CSI-RS resource.

In some implementations, in a case that the target aperiodic RS resource includes the target aperiodic SRS resource, the target aperiodic SRS resource is at least one aperiodic SRS resource in an aperiodic SRS resource set; and in a case that the target aperiodic RS resource includes the target aperiodic CSI-RS resource, the target aperiodic CSI-RS resource is at least one aperiodic CSI-RS resource associated with an aperiodic CSI report.

In some implementations, the transceiver module 602 is configured to: before the target aperiodic RS resource is transmitted or received at the first slot position, receive first request information, where the first request information includes a first activation indication field, and the first activation indication field is for indicating whether to activate the target aperiodic SRS resource; in a case that the first activation indication field indicates to activate the target aperiodic SRS resource, the first slot offset information is for indicating a first slot offset of the target aperiodic SRS resource; and the target aperiodic RS resource is the target aperiodic SRS resource.

In some implementations, the transmission module 601 is configured to: before the target aperiodic RS resource is transmitted or received at the first slot position, transmit second request information, where the second request information includes a second activation indication field, and the second activation indication field is for indicating whether to activate the target aperiodic CSI-RS resource; in a case that the second activation indication field indicates to activate the target aperiodic CSI-RS resource, the first slot offset information is for indicating a first slot offset of the target aperiodic CSI-RS resource; and the target aperiodic RS resource is the target aperiodic CSI-RS resource.

In some implementations, the first slot offset information includes offsetting N target slots, any target slot is any one of the following: an uplink slot, a downlink slot, a special slot, a valid slot, an enable slot, and a random slot, and N is a natural number.

In some implementations, in a case that the first slot offset information is not configured, N is a default value.

In some implementations, the valid slot is a slot resource usable for transmitting the target aperiodic RS resource.

In some implementations, the first slot position satisfies at least one of the following: the first slot position is located in a valid window; a time interval between the first slot position and second slot position is longer than or equal to a first time interval; and a time interval between aperiodic RS resources in the target aperiodic RS resource is longer than or equal to a minimum time interval of antenna switching, where the second slot position is a slot position at which DCI for activating the target aperiodic RS resource is received, and the first time interval is a minimum time interval between DCI for activating an aperiodic RS resource and the aperiodic RS resource.

In some implementations, the valid window is determined by at least one of the following: configured by the network-side device, specified in a protocol, and reported by a terminal.

In some implementations, a slot template of the valid window is determined by at least one of the following: configured by the network-side device, specified in a protocol, and reported by a terminal, where the slot template includes a starting point of the valid window, a window size of the valid window, and a position distribution of enable slots in the valid window.

In some implementations, the starting point of the valid window is located in the second slot position or a third slot position. The third slot position is a slot position determined after the second slot position is offset by the second slot offset.

In embodiments of this application, the network-side device transmits first slot offset information, where the first slot offset information is for indicating a first slot offset of a target aperiodic RS resource; and transmits or receives the target aperiodic RS resource at a first slot position, where the first slot position is determined from any of the following: the first slot offset, and the first slot offset and a second slot offset; and the second slot offset is a slot offset configured for the target aperiodic RS resource. In the solution, the solution of determining a first slot position through a first slot offset or determining a first slot position through a first slot offset and a second slot offset increases the selectability and flexibility of determining a slot position for the terminal to transmit or receive an aperiodic RS resource, so that the problem that a manner of determining a slot position for the terminal to transmit or receive an aperiodic RS resource is not flexible enough in the related technology can be solved. In addition, the solution increases the selectability and flexibility of delivering a slot position of DCI for activating the aperiodic RS resource, that is, increases the selectability and flexibility of a slot position for transmitting a PDCCH, and can resolve to a certain extent the problem of congestion of PDCCH resources caused by delivery of a plurality of pieces of DCI in the same slot in the related technology.

For example, embodiments of this application further provide a network-side device. As shown in FIG. 7, a network-side device 700 includes an antenna 71, a radio frequency apparatus 72, and a baseband apparatus 73. The antenna 71 is connected to the radio frequency apparatus 72. In an uplink direction, the radio frequency apparatus 72 receives information by using the antenna 71, and sends the received information to the baseband apparatus 73 for processing. In a downlink direction, the baseband apparatus 73 processes information to be sent, and sends the information to the radio frequency apparatus 72. The radio frequency apparatus 72 processes the received information and sends the information by using the antenna 71.

A band processing apparatus may be located in the baseband apparatus 73. The method performed by the network-side device in the foregoing embodiments may be implemented in the baseband apparatus 73. The baseband apparatus 73 includes a processor 74 and a memory 75.

The baseband apparatus 73 may include, for example, at least one baseband plate. A plurality of chips are disposed on the baseband plate. As shown in FIG. 7, one of the plurality of chips is, for example, the processor 74, and is connected to the memory 75, to invoke a program in the memory 75 to perform operations of the network-side device in the foregoing method embodiment.

The baseband apparatus 73 may further include a network interface 76, configured to exchange information with the radio frequency apparatus 72. The interface is, for example, a Common Public Radio Interface (CPRI).

For example, the network-side device in embodiments of this application further include: instructions or a program stored in the memory 75 and executable on the processor 74. The processor 74 invokes the instructions or program in the memory 75 to perform the method performed by the module shown in FIG. 6 and achieves the same technical effect. To avoid repetition, details are not described herein again.

Embodiments of this application further provide a readable storage medium. The readable storage medium stores a program or instructions. The program or instructions, when being executed by a processor, implement each process of the foregoing embodiments of the aperiodic RS transmission method, and the same technical effect can be achieved. To avoid repetition, details are not described herein again.

The processor is a processor in the terminal in the foregoing embodiments. The readable storage medium includes a computer-readable storage medium, for example, a computer Read-Only Memory (ROM), a Random Access Memory (RAM), a magnetic disk, an optical disc, or the like.

Embodiments of this application further provide a chip. The chip includes a processor and a communication interface. The communication interface is coupled to the processor are. The processor is configured to execute a program or instructions of a network-side device to implement various processes in embodiments of the aperiodic RS transmission method, and can achieve the same technical effect. To avoid repetition, details are described again.

It should be noted that, the chip mentioned in embodiments of this application may also be referred to as a system-level chip, a system chip, a chip system, a system on chip, or the like.

It should be noted that the terms “include,” “comprise,” or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one . . . ” does not exclude that there are still other same elements in the processes, methods, objects, or apparatuses. Further, it needs to be noted that the scope of the methods and apparatuses in embodiments of this application is not limited to performing the functions in the order shown or discussed, but may also include performing the functions in a substantially simultaneous manner or in the reverse order depending on the functions involved. For example, the described methods may be performed in a different order than described, and various steps may also be added, omitted, or combined. In addition, features described with reference to some examples may be combined in other examples.

Through the descriptions of the foregoing implementations, a person skilled in the art may clearly understand that the methods in the foregoing embodiments may be implemented by means of software and a necessary general hardware platform, and certainly, may also be implemented by hardware, but in many cases, the former manner is a better implementation. Based on such an understanding, the technical solutions of this application essentially or the part contributing to the prior art may be implemented in a form of a software product. The computer software product is stored in a storage medium (such as a ROM/RAM, a magnetic disk, or an optical disc) and includes several instructions for instructing a terminal (which may be a mobile phone, a computer, a server, an air conditioner, a network-side device, or the like) to perform the foregoing methods described in embodiments of this application.

Embodiments of this application are described above with reference to the accompanying drawings. However, this application is not limited to the foregoing specific implementations. The foregoing specific implementations are illustrative instead of limitative. Enlightened by this application, a person of ordinary skill in this application make many forms without departing from the idea of this application and the scope of protection of the claims. All of the forms fall within the protection of this application.

Embodiments of this application are described above with reference to the accompanying drawings. However, this application is not limited to the foregoing specific implementations. The foregoing specific implementations are illustrative instead of limitative. Enlightened by this application, a person of ordinary skill in this application make many forms without departing from the idea of this application and the scope of protection of the claims. All of the forms fall within the protection of this application.

What is claimed is:

1. An aperiodic Reference Signal (RS) transmission method, performed by a terminal, wherein the method comprises:
receiving first slot offset information, wherein the first slot offset information is for indicating a first slot offset of a target aperiodic RS resource; and
transmitting or receiving the target aperiodic RS resource at a first slot position, wherein the first slot position is determined from any of the following:
the first slot offset; or
the first slot offset and a second slot offset, and wherein the second slot offset is a slot offset configured for the target aperiodic RS resource.

2. The method according to claim 1, wherein the receiving first slot offset information comprises:
receiving target information,
wherein the target information comprises a slot offset indication field, the slot offset indication field carries the first slot offset information, and the target information is at least one of the following:
Radio Resource Control (RRC) signaling;
Downlink Control Information (DCI); or
first Media Access Control Control Element (MAC CE) signaling.

3. The method according to claim 2, wherein in a case that the target information is the DCI or the first MAC CE signaling, the first slot offset information is one piece of slot offset information in a slot offset information set, and the slot offset information set is configured for the terminal through the RRC signaling or second MAC CE signaling.

4. The method according to claim 3, wherein in a case that the slot offset information set is empty, the slot offset indication field has 0 bits.

5. The method according to claim 1, wherein the target aperiodic RS resource comprises at least one of the following: a target aperiodic Sounding Reference Signal (SRS) resource or a target aperiodic Channel State Information Reference Signal (CSI-RS) resource.

6. The method according to claim 5, wherein before the transmitting or receiving the target aperiodic RS resource at a first slot position, the method further comprises:
receiving first request information, wherein the first request information comprises a first activation indication field, and the first activation indication field is for indicating whether to activate the target aperiodic SRS resource, and
wherein in a case that the first activation indication field indicates to activate the target aperiodic SRS resource, the first slot offset information is for indicating a first slot offset of the target aperiodic SRS resource, and the target aperiodic RS resource is the target aperiodic SRS resource.

7. The method according to claim 5, wherein before the transmitting or receiving the target aperiodic RS resource at a first slot position, the method further comprises:
receiving second request information,
wherein the second request information comprises a second activation indication field, and the second activation indication field is for indicating whether to activate the target aperiodic CSI-RS resource, and
wherein in a case that the second activation indication field indicates to activate the target aperiodic CSI-RS resource, the first slot offset information is for indicating a first slot offset of the target aperiodic CSI-RS resource; and the target aperiodic RS resource is the target aperiodic CSI-RS resource.

8. The method according to claim 1, wherein the first slot offset information comprises offsetting N target slots, any target slot is any one of the following: an uplink slot, a downlink slot, a special slot, a valid slot, an enable slot, or a random slot, and N is a natural number.

9. The method according to claim 8, wherein in a case that the first slot offset information is not configured, N is a default value.

10. The method according to claim 8, wherein the valid slot is a slot resource usable for the target aperiodic RS resource.

11. The method according to claim 1, wherein the first slot position satisfies at least one of the following:
the first slot position is located in a valid window;
a time interval between the first slot position and second slot position is longer than or equal to a first time interval; or
a time interval between aperiodic RS resources in the target aperiodic RS resource is longer than or equal to a minimum time interval of antenna switching,
wherein the second slot position is a slot position at which Downlink Control Information (DCI) for activating the target aperiodic RS resource is received, and the first time interval is a minimum time interval between DCI for activating an aperiodic RS resource and the aperiodic RS resource.

12. The method according to claim 11, wherein the valid window is determined by at least one of the following: configured by a network-side device, specified in a protocol, or reported by the terminal.

13. The method according to claim 11, wherein a slot template of the valid window is determined by at least one of the following: configured by a network-side device, specified in a protocol, or reported by the terminal,
wherein the slot template comprises a starting point of the valid window, a window size of the valid window, and a position distribution of enable slots in the valid window.

14. A terminal, comprising:
a memory storing computer-readable instructions; and
a processor coupled to the memory and configured to execute the computer-readable instructions, wherein the computer-readable instructions, when executed by the processor, cause the processor to perform operations comprising:
receiving first slot offset information, wherein the first slot offset information is for indicating a first slot offset of a target aperiodic Reference Signal (RS) resource; and
transmitting or receiving the target aperiodic RS resource at a first slot position, wherein the first slot position is determined from any of the following:
the first slot offset; or
the first slot offset and a second slot offset, and wherein the second slot offset is a slot offset configured for the target aperiodic RS resource.

15. The terminal according to claim 14, wherein the receiving first slot offset information comprises:
receiving target information,
wherein the target information comprises a slot offset indication field, the slot offset indication field carries the first slot offset information, and the target information is at least one of the following:
Radio Resource Control (RRC) signaling;
Downlink Control Information (DCI); or
first Media Access Control Control Element (MAC CE) signaling.

16. The terminal according to claim 15, wherein in a case that the target information is the DCI or the first MAC CE signaling, the first slot offset information is one piece of slot offset information in a slot offset information set, and the slot offset information set is configured for the terminal through the RRC signaling or second MAC CE signaling.

17. The terminal according to claim 16, wherein in a case that the slot offset information set is empty, the slot offset indication field has 0 bits.

18. The terminal according to claim 14, wherein the target aperiodic RS resource comprises at least one of the following: a target aperiodic Sounding Reference Signal (SRS) resource or a target aperiodic Channel State Information Reference Signal (CSI-RS) resource.

19. The terminal according to claim 18, wherein before the transmitting or receiving the target aperiodic RS resource at a first slot position, the operations further comprise:
receiving first request information, wherein the first request information comprises a first activation indication field, and the first activation indication field is for indicating whether to activate the target aperiodic SRS resource, and
wherein in a case that the first activation indication field indicates to activate the target aperiodic SRS resource, the first slot offset information is for indicating a first slot offset of the target aperiodic SRS resource, and the target aperiodic RS resource is the target aperiodic SRS resource.

20. The terminal according to claim 18, wherein before the transmitting or receiving the target aperiodic RS resource at a first slot position, the operations further comprise:
receiving second request information,
wherein the second request information comprises a second activation indication field, and the second activation indication field is for indicating whether to activate the target aperiodic CSI-RS resource, and
wherein in a case that the second activation indication field indicates to activate the target aperiodic CSI-RS resource, the first slot offset information is for indicating a first slot offset of the target aperiodic CSI-RS resource, and the target aperiodic RS resource is the target aperiodic CSI-RS resource.
